(19) United States
(12) Patent Application Publication
(10) Pub. No.: US 2007/0068021 A1
(43) Pub. Date: Mar. 29, 2007

(54) Chalk layout line

(76) Inventor: Dan Fisher, Fredericksburg, VA (US)

Correspondence Address: Michael J. Foycik, Jr.;#255, 1718 M St. N.W., Washington, DC, 20036, US

(21) Appl. No.: 11/525,237

(22) Filed: Sep. 21, 2006

Related U.S. Application Data
(60) Provisional application No. 60/719,367, filed on Sep. 22, 2005.

(51) Int. Cl. B44D 3/38

(52) U.S. Cl. 33/414

(57) ABSTRACT

A device for marking a plurality of marks includes a marking line having a plurality of marking elements disposed at predetermined intervals; a marking medium container housing a marking medium and a reeling means, said marking medium container having an aperture for dispensing and retracting said line. The marking elements are marker balls adapted to adhere to chalk. The marker balls are disposed in pairs having first and second marker balls which are separated by one and one-half inches along said marking line, and in which subsequent ones of said pairs are spaced such that the first marker ball of each pair is separated from an adjacent first marker ball of an adjacent pair by a distance of sixteen inches. In a second embodiment, the spacing between adjacent first marker balls is twenty four inches, and in a third embodiment the spacing between adjacent first marker balls is a distance of nineteen and three-sixteenth inches.

### FIELD OF THE INVENTION

The present invention relates to chalk layout lines, useful in construction and building.

### BACKGROUND OF THE INVENTION

At the pace of technological change, there is a great demand for construction projects to build, improve, or modernize a structure. The marking of spaces to place lumber, whether for wall studs, floor joists, rafters, or trusses, is a time-consuming process.

Accordingly, it is a problem in the art to provide a chalk layout line which is relatively easy to use, and which lays out standard distances for various types of construction projects, for example for marking the locations to place lumber, whether wall studs, floor joists, rafters, or trusses.

A prior art type of reel and chalk line is shown in FIGS. 1-6. This type of prior art device is shown, for example, in U.S. Pat. No. 6,826,845 issued to Pritchard on Dec. 7, 2004 In these prior art figures, FIG. 1 illustrates a cut away side view of an embodiment 100 of a marking apparatus. The body 102 contains a tape spool 104 and a chalk line spool 106. As the free end tip 108 is pulled away from the body 102, the tape 110 and chalk line 112 are extended with the chalk line 112 being located over or spanning the tape 110. The tape 110 has a series of marking holes 114 at predetermined intervals. The tape 110 and chalk line 112 can be simultaneously retracted into the body 102 by the rewind crank 116. The chalk line 112 travels through holes in stanchions 118 and 120 and tensioner 112.

In operation, one places the tip 108 of the device over the edge of a surface to be marked, then extends the tape 110 and chalk line 112 simultaneously along the length to be marked. When the tape in the marking apparatus 100 is extended over the length to be marked, the body 102 may be placed on top of the surface such that the lower arm 124 of the tensioner 112 is pressed against the surface. The tensioner 112 forces the chalk line 112 against the tape with the tensioning arm 126. The exposed chalk line 112 is stretched between stanchions 118 and 120 with one hand and the chalk line 112 is lifted and quickly released against the tape 110 with the other hand, allowing the chalk line to return to its normal position in a process known as ‘snapping the line.’ The chalk dust that is supported on the chalk line 112 transfers through the marking holes 114 and make marks on the board at those intervals.

The tape 110 may be a standard metal measuring tape that has markings typical to commercially available measuring tapes. The tape 110 may be constructed of steel or other metal, or may be constructed of plastic or other suitable material.

The marking holes 114 may be placed at periodic intervals that may be useful to those of the building trades. For example, it is common to mark studs and other building components on sixteen or twenty four inch intervals. Thus, the marking holes 114 may be placed at those intervals. In addition, it is often necessary to offset those intervals by a standard amount, such as one half of the width of a stud. Additional offset holes may be provided near the tip 108 to offset the marking holes 114. A nail may be placed in the board and one of the offset holes may be placed over the nail to offset the markings a particular distance. For example, an offset of three-quarters of an inch may be desirable for laying out stud placement. A nail may be placed in the end of the board and an offset hole that is three-quarters of an inch from the tip 108 may be placed over the nail. Thus, for the entire length of the tape, all of the markings can be offset by three quarters of an inch. Other offsets may be accomplished by providing offset holes at predetermined locations along the tape. In another embodiment, the tape 110 may have a series of offset holes through which a nail may be inserted. The nail may then be placed over the edge of a board to offset the markings made by the embodiment 100. In still other embodiments, the tip 108 may be movable such that it may be adjusted to different positions along the axis of the tape 110 in order to offset the marks made by the embodiment 100.

The chalk line 112 may be a common string that is stored on a chalk line spool 106. The chalk line spool 106 may be enclosed by a chalk compartment in which chalk is stored and by which chalk may become entrained by the string. In other embodiments, the string may be replaced by a woven band with a width greater than its thickness that may be able to produce marks wider than would be possible with a string.

The marking holes 114 may be small circular holes or may be a specially shaped hole that may produce a specially shaped mark. Such shapes may include numerical shapes that may mark the location with a numerical designation. In other embodiments, the marking holes 114 may include a mark for the edge of a stud or other building member and a second mark or designation for the side to which the stud is to be placed. It is common for a carpenter to mark a location with a line or crow's foot mark and then place an ‘X’ to designate the appropriate side of the line for the stud. Such marks may be placed by an embodiment having an ‘X’ shaped hole.

The tensioner 112 operates by rotating about the hinge point 128. As the body 102 is placed upon a surface, the lower arm 124 causes the tensioner 122 to rotate and slightly stretch the chalk line 112 with the tensioning arm 126. In some embodiments, the amount of tension applied by the tensioning arm 126 may be sufficient to snap the chalk line 112 and effectively place marks along the board. In other embodiments, the carpenter may push the body 102 against the board and pull the chalk line 1112 taught by pulling on the chalk line 112 in the area between the stanchions 118 and 120.

The rewind crank 116 may be used to retract the tape 110 and chalk line 112 into the body 102. The rewind crank 116 may be connected to the tape spool 104 and chalk line spool 106 by various gears, pulleys, or other mechanisms such that the tape 110 and chalk line 112 may be retracted substantially simultaneously. In other embodiments, a return spring may be used in place of the rewind crank 116. In such embodiments, the tape spool 104 and chalk line spool 106 may be connected by a mechanism that allows for the simultaneous retraction of the tape 110 and chalk line 112.

FIG. 2 is a partial cut away front view of the embodiment 100 of a marking apparatus. The body 202 has a tape housing 204 and a chalk line housing 206. The return crank 208 is mounted so that it can retract the chalk line and tape into the body 202. The chalk line 210 is fed through stanchions 214 and 216 to the tip 212. The wall 218 separates the chalk line housing 206 from the tape housing 204. The chalk line housing 206 may have a door into which may poured a quantity of chalk dust. The chalk dust may then become entrained on the chalk line 210.

Various embodiments may have different mechanisms for handling the chalk dust. For example, wipers and mechanisms of various sorts may be employed to remove excess chalk dust from the tape or chalk line. Such mechanisms regulate the amount of chalk that is entrained on the chalk line and to clean the tape during rewind to prohibit chalk dust from collecting inside the tape housing 204.

FIG. 3 illustrates a perspective view of an embodiment 300 of the present invention of a marking apparatus. The body 302 contains a tape spool 304 and a string spool 306. A tape locking lever 308 allows the tape to be locked in a particular position. A chalk filling door 310 may be opened to receive powdered chalk that can be carried on the string 314. The free end of the tape 312 may be hooked over the edge of a piece of wood or other article to be measured or marked. The string end clip 316 may be engaged on the post 317 when the device is used as a marking instrument.

The embodiment 300 may be used as a separate tape measure and string line. For example, to use the embodiment 300 as a tape measure, the string end clip 316 may be disengaged from the tape end clip 312 and stored in the string end clip holder 318. The tape may be extended from the tape spool 304 by pulling on the tape end clip 312. The tape may be an elongated sheet of metal or plastic and may have graduations, marks, or other indicia for measuring or otherwise indicating distance. Similarly, the tape may be kept in the retracted position and the string may be extended to mark or indicate a straight line.

FIG. 4 illustrates a perspective view of an embodiment 400 of the present invention of a marking apparatus. The body 402 contains a tape spool 404 and a string spool 406. A tape locking lever 408 may lock the tape in a particular position. A chalk filling door 410 may be opened to receive powdered chalk or other marking medium that can be carried on the string 414. The tape end clip 412 has a post 417 that may receive the string end clip 416.

The embodiment 400 contains a string retract crank 418 that may engage the string spool 406 to retract the string 414 into the body 402. In some embodiments, the crank 418 may engage the string spool directly or may engage the spool by means of gears.

In some embodiments, the tape may be retracted by a spring mechanism. In some embodiments, the string and the tape may be retracted simultaneously and collectively by a gear mechanism between the tape spool and the string spool. In other embodiments, the tape and the spring may be retracted separately and using separate devices. For example, the tape may be retracted with a spring powered mechanism while the string is retracted by a hand crank mechanism. Various retraction mechanisms may be used by those skilled in the art.

The string 414 may carry chalk or other marking medium and may be used to transfer the marking medium to an article to be marked. In some instances, the string may contain powdered chalk, powdered ink, liquid ink, or other marking fluid or powder.

FIG. 5 illustrates a perspective view of an embodiment 500 of the present invention of a marking apparatus. A measuring tape 502 contains a plurality of apertures 504 at predetermined intervals or other spacing. The tape clip 506 may be hooked over the edge of an article to mark. A chalk line 510 may be placed over the tape 502 by engaging the string end clip 512 over the post 508 of the tape end clip 506. The string 510 is placed directly on top of the tape 502, spanning the apertures 504. When the string 510 is made taught, the chalk line 510 may be raised and released quickly to transfer the marking medium carried by the chalk line 510 through the apertures 504 and onto the item to be marked. This process is sometimes called ‘snapping a line’ in the trade.

The apertures 504 may be selected to be of various shapes, sizes, and spacing to indicate various distances or marks as those skilled in the art may desire. For example, for framing houses in the United States, it may be conventional to mark studs at 16 inches apart. In such a case, the apertures 504 may be spaced 16 inches apart. In some cases, the shape of an aperture 504 may have a special meaning, such as the stud side of a mark.

In some cases, the measuring tape 502 may have various marks or indicia for measuring distance or other functions as desired.

FIG. 6 is a perspective view of an embodiment 600 of the present invention of a marking apparatus. A tape body 602 contains a tape 604 and a tape locking tab 606. A chalk line body 608 contains a string 610, a string end clip 612, a retraction crank 614, and a chalk filling door 616. The chalk line body 608 may removably engage the tape body 602 with a locking/locating feature 618.

The embodiment 600 allows the string line body 608 to be removed and separately used from the tape body 602, but be recombined in order to use apertures in the tape 604 to mask the chalk line 610 to make separate, distinct marks along the length of the tape 604. For example, the chalk line 610 may be used for marking a straight line while the tape measure 602 may be used to measure a certain distance. After such time, the chalk line 610 may be reattached to the tape measure 602 and used to mark a plurality of points along a distance.

Various locating and locking mechanisms 618 may be used by those skilled in the art while keeping within the spirit and intent of the present invention. For example, the tape measure 602 and the chalk line 610 may snap together, may lock together using a mechanical linkage, may slidingly engage each other, or any other type of releasable engagement device or mechanism.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides a chalk line layout device especially adapted for efficiency in standard construction activities.

More particularly, the invention relates to a device for marking a plurality of marks. The device includes a marking line having a plurality of marking elements disposed at predetermined intervals; a marking medium container housing a marking medium and a reeling means, said marking medium container having an aperture for dispensing and retracting said line. The marking elements are marker balls adapted to adhere to chalk. The marker balls are disposed in pairs having first and second marker balls which are separated by one and one-half inches along said marking line, and in which subsequent ones of said pairs are spaced such that the first marker ball of each pair is separated from an adjacent first marker ball of an adjacent pair by a distance of sixteen inches.

In a second embodiment, the spacing between adjacent first marker balls is twenty four inches, and in a third embodiment the spacing between adjacent first marker balls is a distance of nineteen and three-sixteenth inches.

It is a further object of the present invention to provide specialty materials and construction methods for the marker balls.

Other objects and advantages of the present invention will be more readily apparent from the following detailed description when read in conjunction with the accompanying drawings.

### BRIEF DESCRIPTION OF THE DRAWINGS

FIG. 1 is a partial cut away side view illustration of a prior art embodiment of a marking apparatus.

FIG. 2 is a partial cut away front view illustration of the embodiment of the prior art marking apparatus shown in FIG. 1.

FIG. 3 is a perspective view of an embodiment of a prior art marking apparatus.

FIG. 4 is a perspective view of the embodiment of the prior art marking apparatus shown in FIG. 3.

FIG. 5 is a perspective view of an embodiment of the prior art marking apparatus showing the marking components.

FIG. 6 is a perspective view of an embodiment of the prior art marking apparatus having detachable components.

FIG. 7 is a schematic side elevational view of a chalk layout line according to the present invention.

FIG. 8 is a schematic side elevational view of an alternative line usable in the chalk layout line of FIG. 7, according to the present invention.

FIG. 9 is another schematic side elevational view of an alternative line usable in the chalk layout line of FIG. 7, according to the present invention.

FIG. 10 is an elevational view of an embodiment of a bead usable in the present invention having charged regions to attract chalk.

FIG. 11 is an elevational view of another embodiment of a bead usable in the present invention, having dimples and charged regions in the dimples.

FIG. 12 is an elevational view of another embodiment of a bead usable in the present invention, having an electrically conductive wire passing therethrough and having charged regions.

### DETAILED DESCRIPTION OF THE INVENTION

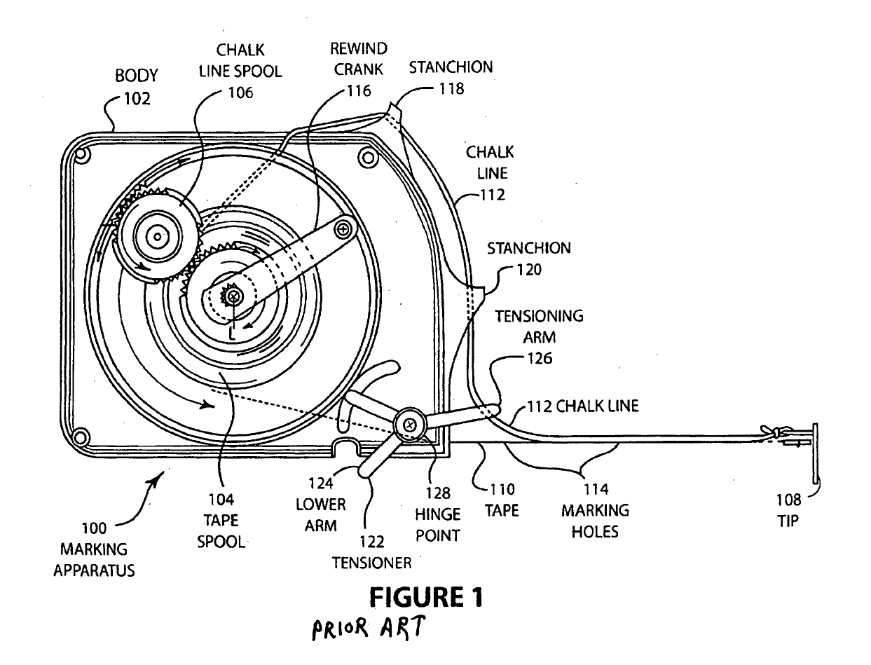

FIG. 1 illustrates a device 1 for marking a plurality of marks with chalk. More specifically, the device 1 includes a marking medium container 10, referred to hereafter as a chalk container 10, having an attached marking line 30. The marking line 30 carries a plurality of marking elements 50 disposed at predetermined intervals. The marking line 30 terminates in a hook 40 which is preferably a metal hook.

The marking line 30 is used to provide spacing for standard types of construction projects to build, improve, or modernize a structure. The marking of spaces to for placement of lumber, whether for wall studs, floor joists, rafters, or trusses. Such marking by hand measurement is usually a time-consuming process, whereas device 1 of the present invention having the marking line 30 and marking balls 50 can accomplish this in much less time, and with greater accuracy, than by manual methods of measurement.

The device 1 of the present invention, having a chalk layout line 30 which is relatively easy to use, enables rapid and accurate laying out of standard distances for various types of construction projects. For example, such construction projects may include among others the marking of locations to place lumber, whether for wall studs, floor joists, rafters, or trusses.

The line 30 preferably does not stretch, or at least does not stretch within a relatively small tolerance of no more than about one-sixty fourth inch.

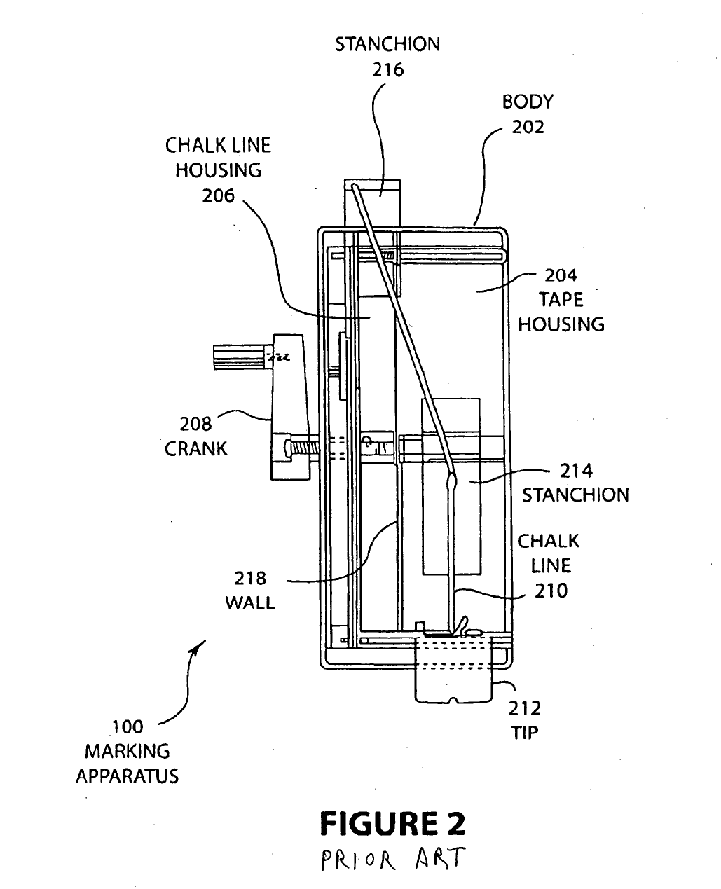

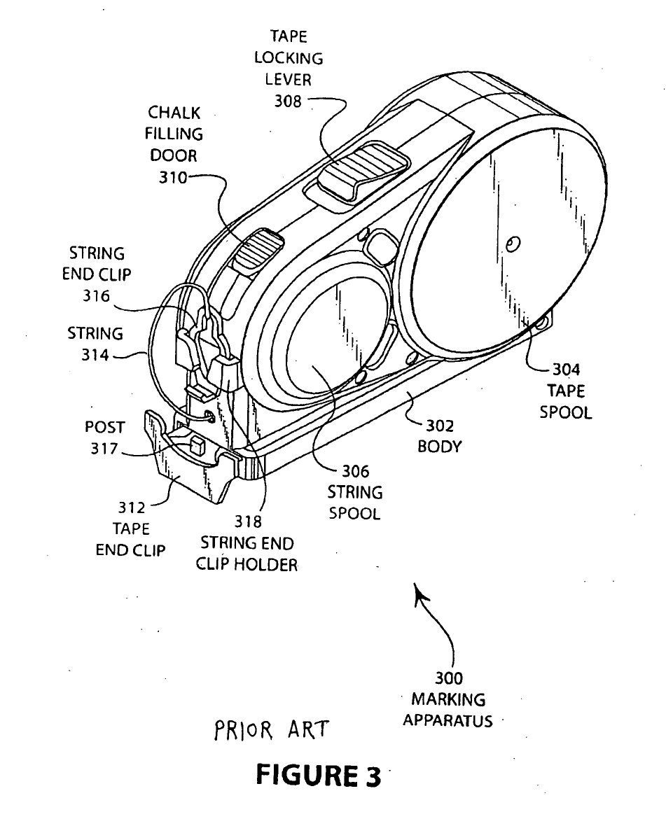

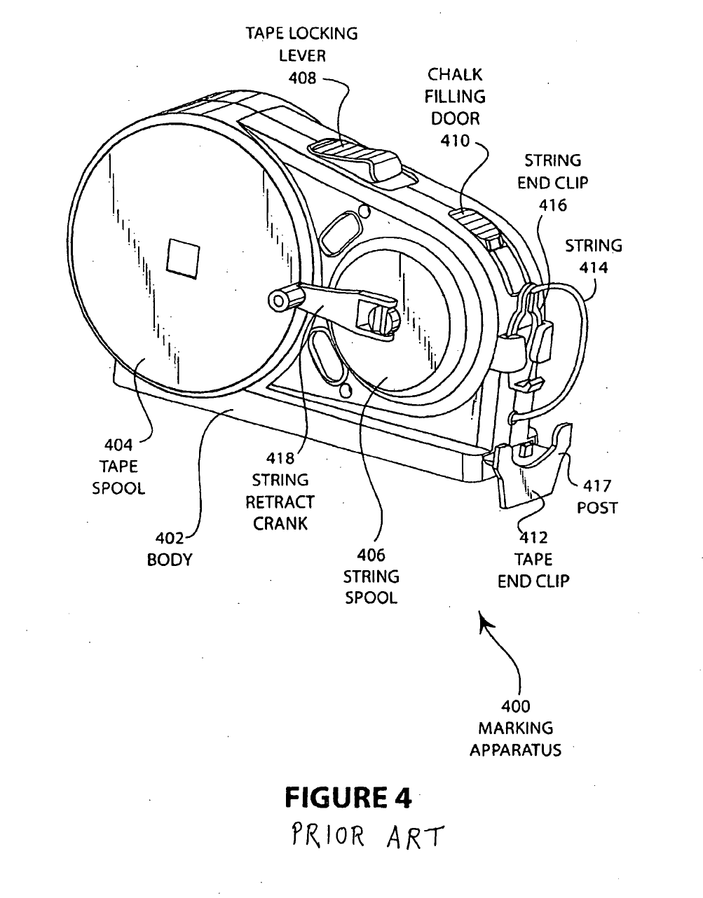

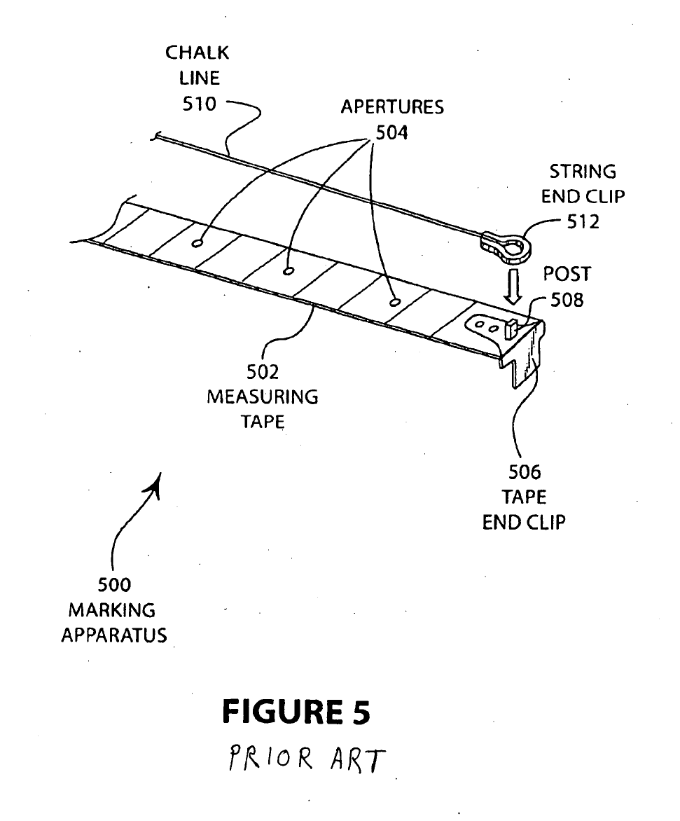

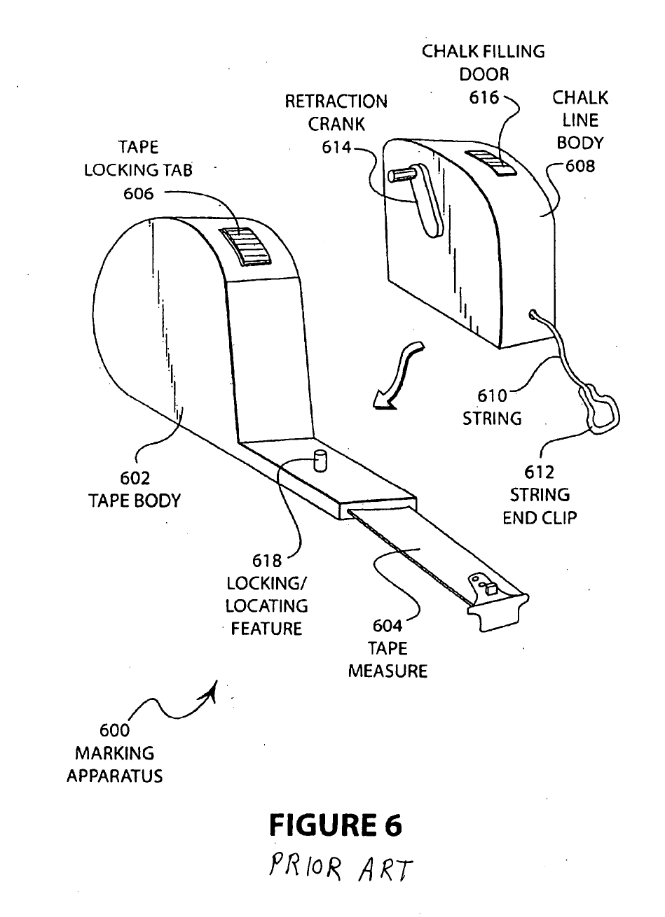

The chalk container 10 has a housing which contains the marking medium or chalk, and also includes a reeling means (not shown in FIG. 7). Sample reeling means are shown in FIGS. 1-6, or other reeling means may be used.

The chalk container 10 has an aperture 20 which is a metal feed ramp 20, for dispensing and retracting the marking line 30. The marking elements 50 are marker balls 50 which are adapted to adhere to chalk or other marking medium.

The marker balls 50 are disposed in pairs having first and second marker balls 50a, 50b, which are separated by one and one-half inches along the marking line 30. Subsequent ones of these pairs 50a, 50b are spaced such that the first marker ball 50a of each pair is separated from an adjacent first marker ball 50a of an adjacent pair by a distance of sixteen inches.

In a second embodiment shown in FIG. 8, the marker balls 50 are similarly disposed in pairs having first and second marker balls 50a, 50b, which are separated by one and one-half inches along the marking line 30. Subsequent ones of these pairs 50a, 50b are spaced such that the first marker ball 50a of each pair is separated from an adjacent first marker ball 50a of an adjacent pair by a distance of twenty four inches.

FIG. 9 shows a third embodiment in which the marker balls 50 are likewise disposed in pairs having first and second marker balls 50a, 50b, which are separated by one and one-half inches along the marking line 30. Subsequent ones of these pairs 50a, 50b are spaced such that the first marker ball 50a of each pair is separated from an adjacent first marker ball 50a of an adjacent pair by a distance of nineteen and three-sixteenth inches.

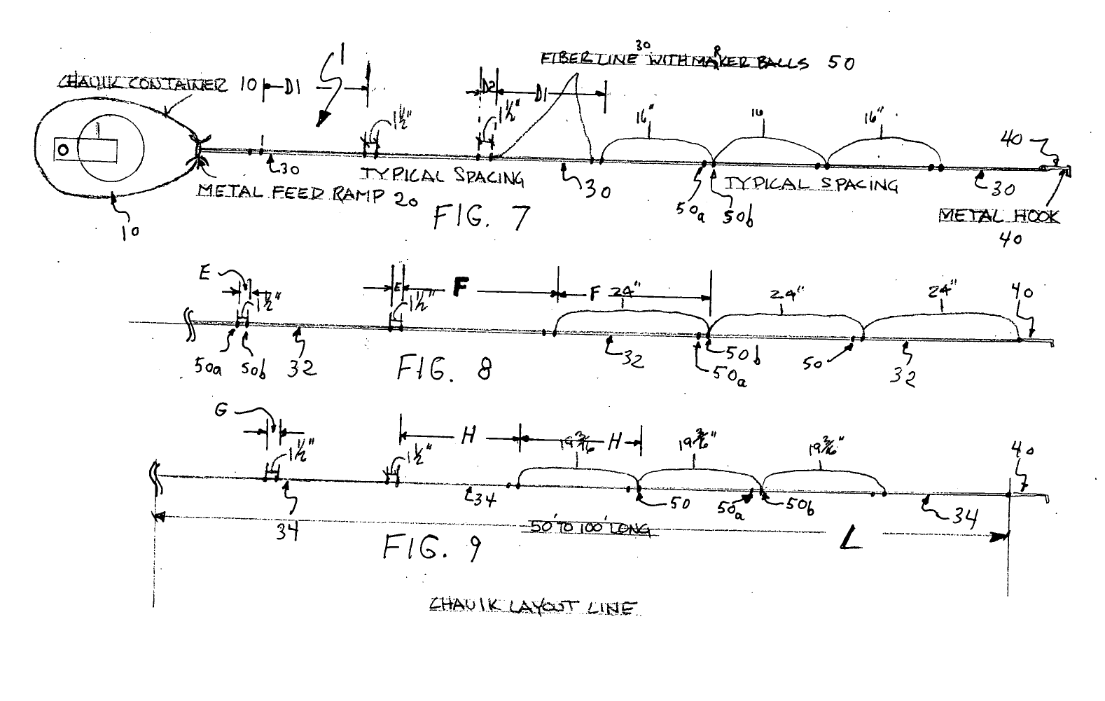

FIG. 10 is an elevational view of an embodiment of a bead 800 which is usable in the present invention in place of the beads 50, including beads 50a, and 50b. The bead 800 has a plurality of charged regions 801 (indicated by plus signs), which assist in attracting chalk to the bead. The bead 800 in this embodiment is preferably composed of a insulating material such as glass or plastic, and the charged regions can be created in a manner which would be well known to anyone in the photocopier arts. Alternatively, instead of chalk, standard types of printer toner could be used, which would be weakly attracted to the charged regions 801 so as to adhere to the bead 800. A sufficient number of charged regions are preferably provided to aid in attracting chalk to the bead 800, at a relatively weak strength such that a mechanical shaking of the string carrying the bead 800 will dislodge the chalk.

FIG. 11 is an elevational view of another embodiment of a bead 802 usable in the present invention instead of the beads 50, 50a, or 50b, the bead 802 having a plurality of dimples 803 therein and charged regions 804 in the dimples 803. The dimples 803 are for retention of chalk so as to improve the amount of chalk carried per bead 802, and the charged regions 804 are to assist in attracting and retaining chalk. The charged regions 804 are indicated by plus signs in FIG. 11. The bead 802 in this embodiment is preferably composed of a insulating material such as glass or plastic, and the charged regions can be created in a manner which would be well known to anyone in the photocopier arts. Alternatively, instead of chalk, standard types of printer toner could be used, which would be weakly attracted to the charged regions 804 so as to adhere to the bead 802. A sufficient number of charged regions are preferably provided to aid in attracting chalk to the bead 802, at a relatively weak strength such that a mechanical shaking of the string carrying the bead 802 will dislodge the chalk.

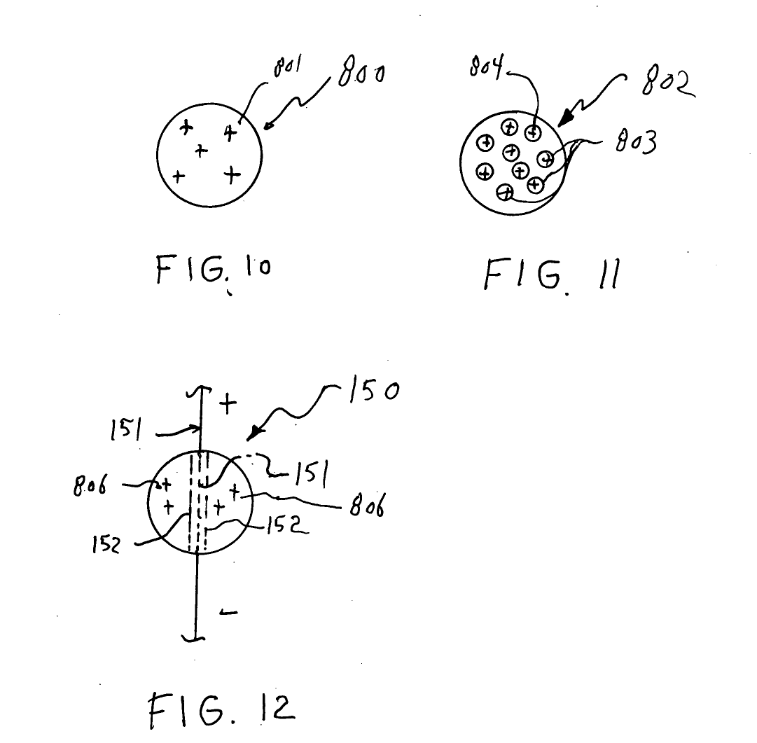

FIG. 12 is an elevational view of another embodiment of a bead 150 usable in the present invention instead of the beads 50, 50a, or 50b, the bead 150 having an electrically conductive wire 151 passing therethrough and having a plurality of charged regions 806. The bead 150 has a passageway or bore 152 formed therethrough to receive the wire 151. The wire 151 has a voltage applied thereto in FIG. 12 as shown by the positive and negative signs in this figure. The voltage can be changed, reversed, or removed altogether by a signal from the user in a manner which would be well within the ambit of skill of anyone in the electrical circuit arts. The voltage can be used to selectively retain chalk or toner on the beads 150, and to assist in the removal or elimination of the chalk or toner from the beads 150. The circuit can be arranged to automatically change the polarity of the voltage or remove the voltage altogether when the wire 151 carrying the bead 150 is snapped. The charged regions 806 are to assist in attracting and retaining chalk. The charged regions 806 are indicated by plus signs in FIG. 12. The bead 150 in this embodiment is preferably composed of a insulating material such as glass or plastic, and the charged regions can be created in a manner which would be well known to anyone in the photocopier arts. Alternatively, instead of chalk, standard types of printer toner could be used, which would be weakly attracted to the charged regions 806 so as to adhere to the bead 150. A sufficient number of charged regions are preferably provided to aid in attracting chalk to the bead 150, at a relatively weak strength such that a mechanical shaking of the string carrying the bead 150 will dislodge the chalk.

The dimensions set forth above are by way of example only, and these dimensions can vary without departing from the scope of the present invention.

In use, as the layout line 30 is pulled out of the chalk container 10, chalk will cling to the marker balls 50. The line 30 is then placed on the wall plate or whatever surface needs to be marked for lumber placement. The line 30 will then be manually snapped to transfer marks from the marker balls 50 to the surface to be marked.

The invention being thus described, it will be evident that the same may be varied in many ways. Such variations are not to be regarded as a departure from the spirit and scope of the invention and all such modifications are intended to be included within the scope of the claims.

What is claimed is:

1. A device for marking a plurality of marks comprising:
a marking line having a plurality of marking elements disposed at predetermined intervals;
a marking medium container housing a marking medium and a reeling means, said marking medium container having an aperture for dispensing and retracting said line.

2. The device of claim 1 wherein said marking elements are comprised of marker balls adapted to adhere to chalk.

3. The device of claim 1, wherein said marker balls are disposed in pairs having first and second marker balls which are separated by one and one-half inches along said marking line; and wherein subsequent ones of said pairs are spaced such that the first marker ball of each pair is separated from an adjacent first marker ball of an adjacent pair by a distance of sixteen inches.

4. The device of claim 1, wherein said marker balls are disposed in pairs having first and second marker balls which are separated by one and one-half inches along said marking line; and wherein subsequent ones of said pairs are spaced such that the first marker ball of each pair is separated from an adjacent first marker ball of an adjacent pair by a distance of twenty four inches.

5. The device of claim 1, wherein said marker balls are disposed in pairs having first and second marker balls which are separated by one and one-half inches along said marking line; and wherein subsequent ones of said pairs are spaced such that the first marker ball of each pair is separated from an adjacent first marker ball of an adjacent pair by a distance of nineteen and three-sixteenth inches.

6. The device of claim 1, wherein said marker balls having a plurality of charged regions thereon.

7. The device of claim 1, wherein said marker balls have a plurality of dimples thereon for retention of chalk, and each dimple has a charged region for attracting chalk into the dimple.

8. The device of claim 1, wherein said marker balls have a passageway therethrough and have a plurality of charged regions thereon; and wherein said marking line is electrically conductive and has a voltage applied thereto to assist in retention or removal of chalk.
